(19) United States
(12) Patent Application Publication
(10) Pub. No.: US 2005/0285518 A1
(43) Pub. Date: Dec. 29, 2005

(54) OLED display having thick cathode

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/876,145

(22) Filed: Jun. 24, 2004

(51) Int. Cl. H05B 33/00

(52) U.S. Cl. 313/512

(57) ABSTRACT

A bottom-emitting OLED device comprising: a) a transparent substrate; b) a plurality of OLED light emitting elements located on the substrate, each light emitting element including a first patterned transparent electrode formed over the substrate and one or more OLED light emissive layers located over the first electrode and emitting light through the first electrode, and a continuous second electrode metallic layer located over the plurality of OLED light emitting elements, wherein the second electrode metallic layer has a continuous thickness greater than 500 nm over and between the light emitting elements; and c) an encapsulating cover located over the second electrode.

### FIELD OF THE INVENTION

The present invention relates to active-matrix organic light-emitting diode devices. In particular, the present invention relates to improving device lifetime and reducing localized non-uniformity in an OLED device due to heating within an organic light-emitting display device.

### BACKGROUND OF THE INVENTION

Organic light-emitting diode (OLED) display devices typically include a substrate having one or more OLED light-emitting elements including a first electrode formed thereon, one or more OLED light-emitting layers located over the first electrode, and a second electrode located over the OLED light-emitting layers, and an encapsulating cover located over the second electrode, affixed to the substrate. Such an OLED device may be top-emitting, where the light-emitting elements are intended to emit through the cover, and/or bottom-emitting, where the light-emitting elements are intended to emit through the substrate. Accordingly, in the case of a bottom-emitting OLED device, the substrate and first electrode must be largely transparent, and in the case of a top-emitting OLED device, the cover and second electrode must be largely transparent.

Referring to FIG. 2, a commercially available active-matrix bottom-emitter OLED device includes a substrate 10 on which is deposited one or more first electrodes 20, one or more organic layers 22 (at least one of which is emissive when a current is passed through the layers) and a second, common electrode 24. A cover 12 is affixed to the substrate and seals the OLED materials from the environment. A cavity 14 exists between the second electrode 24 and the cover 12 and is usually filled with an inert gas and may include desiccant materials. In this bottom-emitter configuration, light 40 is emitted through the substrate 10 so that the substrate 10 and first electrode 20 must be transparent while the cover 12 and the second electrode 24 may be opaque or reflective. The second electrode 24 is typically unpatterned and is applied as a continuous film over the organic layers 22.

As disclosed in the prior art, the first electrode 20 may be an anode and the second electrode 24 may be a cathode. Alternatively, the second electrode 24 may be an anode and the first electrode 20 may be a cathode: However, the second electrode 24 deposited on top of the OLED material layers 22 is more conventionally described as a cathode and this terminology is used herein without limiting the application of the present invention to such a structure. The OLED material layers may comprise one or more of a hole-injection layer, hole-transport layer, emissive layer, electron-transport layer, and electron injection layer as is known in the art.

Organic light-emitting diodes can generate efficient, high-brightness displays. However, heat generated during the operation of the display in high-brightness modes can limit the lifetime of the display, since the light-emitting materials within an OLED display degrade more rapidly when used at higher temperatures. While it is important to maintain the overall brightness of an OLED display, it is even more important to avoid localized degradation within a display. The human visual system is acutely sensitive to differences in brightness in a display. Hence, differences in uniformity are readily noticed by a user. Such localized differences in uniformity in an OLED display may occur as a consequence of displaying static patterns on the display, for example, graphic user interfaces often display bright icons in a static location. Such local patterns will not only cause local aging in an OLED display, but will also create local hot spots in the display, further degrading the light-emitting elements in the local pattern. Glass and plastic supports, the use of which is advantageous in view of their relative electrical non-conductivity, may not be sufficiently thermally conductive to provide a uniform temperature across the substrate when the display is in operation. Hence, improved thermal management techniques may significantly improve the life expectancy of an organic display device.

In a bottom emitter structure such as the structure illustrated in FIG. 2, the second electrode 24 typically provides at least two functions. First, it must be capable of carrying the current for all of the light emitting elements in the OLED device. Because the second electrode 24 is unpatterned, the current for any and all light emitting elements simply travels through the second electrode layer. Second, the second electrode 24 serves as a barrier layer to humidity and environmental contaminants that would otherwise attack the sensitive OLED materials. In typical use and as found in commercial products, the second electrode layer in an active-matrix bottom emitter OLED device is composed of metals, for example silver, aluminum, magnesium and compounds of such metals. These metals provide a high conductivity and are readily deposited. The metal layer is typically 1,000 to 2,000 Angstroms (100 to 200 nm) thick. For example, US6274979 B1 entitled “Organic light emitting diodes” issued Aug. 14, 2001 describes a 200 nm thick aluminum cathode for a passive-matrix OLED display. Such a thickness has been found to provide adequate conductivity and protection to the underlying organic layers. However, as is well known, the electrical conductivity requirements for passive-matrix device electrodes are higher than those for active-matrix devices since the instantaneous current is much higher in passive-matrix driven devices. In an active-matrix device such as that of the present invention, the second electrode may be thinner than that of a passive-matrix device and still carry adequate amounts of current. Nonetheless, in current commercial practice, for example as is seen in the Kodak AM 550L active-matrix OLED product, a second aluminum cathode of a 400 nm thickness is employed. Such a thickness provides adequate electrical conductivity and environmental robustness, but is limited in its ability to spread heat and thereby improve device lifetime.

US 20040094768A1 entitled “Methods for Producing Full-Color Organic Electroluminescent Devices” by Yu et al filed Aug. 18, 2003 describes pixels comprising ink-jet deposited polymer OLED materials deposited inside walled cavities. Such reference indicates that thickness of the cathode layer in such devices may be, for example, approximately 50-500 nm, and is usually no greater than approximately 1000 nm thick. As indicated in the Figures of such reference, however, the cathode layer must fill the cavities while also providing electrical conduction between the pixels, and the cathode layer thickness between pixels may be substantially less than that which fills the cavities. There is no disclosure of a cathode layer having any particular continuous thickness to provide desired heat spreading. Similarly, in US6590554B1 entitled “Color Image Display System” by Takayama, filed Nov. 1, 2000, 500 nm is cited as the upper useful limit of cathode thickness. JP 10-275681 discloses an organic electroluminescent light source having a light emitting element with a relatively thick cathode and a surrounding protecting layer to provide high heat conductivity. However, as described for this arrangement, there is no disclosure of use of such thick cathode in a device comprising a plurality of light emitting elements, nor of the need to spread heat between an active light emitting element and an inactive light emitting element in or to reduce differential aging of such light emitting elements.

One method of removing heat from an organic light emitting display device is described in U.S. Pat. No. 6,265,820, entitled, “Heat removal system for use in organic light emitting diode displays having high brightness.” The '820 patent describes a heat removal system for use in organic light emitting diode displays. The heat removal assembly includes a heat dissipating assembly for dissipating heat from the organic light emitting device, a heat transfer assembly for transferring heat from the top organic light emitting device to the heat dissipating assembly and a cooling assembly for cooling the organic light emitting display device. While the system of the '820 patent provides a means for heat removal in an OLED application, its efficiency is limited by the presence of a glass substrate having poor thermal conductivity characteristics through which heat generated by the OLED devices must transfer for removal. Moreover, the structure described in the '820 patent is complex, requiring multiple layers and specific, heat transfer materials in contact with delicate OLED layers.

U.S. Pat. No. 6,480,389 to Shie et al entitled “Heat dissipation structure for solid-state light emitting device package” describes a heat dissipation structure for cooling inorganic LEDs and characterized by having a heat dissipating fluidic coolant filled in a hermetically sealed housing where at least one LED chip mounted on a metallic substrate within a metallic wall erected from the metallic substrate. Such an arrangement is complex, requires fluids, and is not suitable for area emitters such as OLEDs.

US 2004/0004436 A1 entitled “Electroluminescent display device” by Yoneda published Jan. 8, 2004, describes an organic EL panel having a device glass substrate provided with an organic EL element on a surface thereof, a sealing glass substrate attached to the device glass substrate, a desiccant layer formed on a surface of the sealing glass substrate, and spacers disposed between a cathode of the organic EL element and a desiccant layer. A heat-conductive layer can be formed by vapor-depositing or sputtering a metal layer such as a Cr layer or an Al layer that inhibits damaging the organic EL element and increases a heat dissipating ability, thereby inhibiting aging caused by heat. This heat-conductive layer is located on the inside of an encapsulating cover and is in thermal contact with heat-conductive spacers. This design requires the use of additional spacers and coatings on the inside of the cover and is problematic to assemble without damaging the OLED device.

US6633123 B2 entitled “Organic electroluminescence device with an improved heat radiation structure” issued Oct. 14, 2003 provides an organic electroluminescence device including a base structure and at least an organic electroluminescence device structure over the base structure, wherein the base structure includes a substrate made of a plastic material, and at least a heat radiation layer which is higher in heat conductivity than the substrate. While this is useful for conducting heat through a plastic substrate, it does not assist in conducting heat away from the emissive layer itself.

It is therefore an object of the present invention to provide a more uniform distribution of heat within an OLED device and to improve the removal of heat from an OLED device thereby increasing the lifetime of the display.

### SUMMARY OF THE INVENTION

In accordance with one embodiment, the invention is directed towards a bottom-emitting OLED device comprising: a) a transparent substrate; b) a plurality of OLED light emitting elements located on the substrate, each light emitting element including a first patterned transparent electrode formed over the substrate and one or more OLED light emissive layers located over the first electrode and emitting light through the first electrode, and a continuous second electrode metallic layer located over the plurality of OLED light emitting elements, wherein the second electrode metallic layer has a continuous thickness greater than 500 nm over and between the plurality of light emitting elements; and c) an encapsulating cover located over the second electrode.

### BRIEF DESCRIPTION OF THE DRAWINGS

FIG. 1 is a schematic diagram of a bottom-emitting OLED device according to one embodiment of the present invention;

FIG. 2 is a schematic diagram of a bottom-emitting prior-art OLED device;

FIG. 3 is a schematic diagram of a bottom-emitting OLED device according to another embodiment of the present invention;

FIG. 4 is a schematic diagram of a bottom-emitting OLED device according to an alternative embodiment of the present invention;

FIG. 5 is a schematic diagram of a bottom-emitting OLED device according to yet another alternative embodiment of the present invention;

FIG. 6 is a thermal model of a bottom-emitting OLED device according to the prior art;

FIG. 7 is a thermal model of a bottom-emitting OLED device according to the embodiment of FIG. 1;

FIG. 8 is a thermal model of a bottom-emitting OLED device according to the embodiment of FIG. 3; and

FIG. 9 is a thermal model of a bottom-emitting OLED device according to the embodiment of FIG. 5.

### DETAILED DESCRIPTION OF THE INVENTION

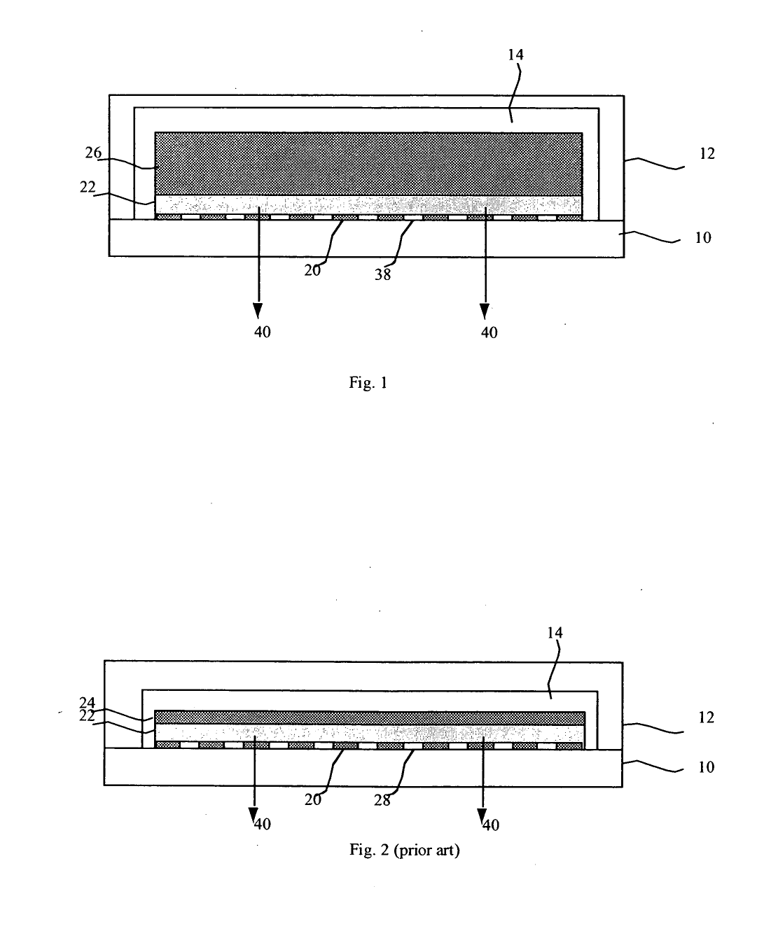

Referring to FIG. 1, a bottom-emitter embodiment of the present invention includes a transparent substrate 10, a plurality of OLED light emitting elements located on the substrate, each light emitting element including a first patterned transparent electrode 20 formed over the substrate (separated by insulators 38) and one or more OLED light emissive layers 22 (at least one of which is emissive when a current is passed through the layers) located over the first electrodes and emitting light 40 through the first electrodes, and a thick, metallic, continuous common second electrode 26. An encapsulating cover 12 is affixed to the substrate and seals the OLED materials from the environment. The thick metallic second electrode may be made of one or more layers of a metal or metal alloy, for example silver, aluminum, or magnesium, and has a continuous thickness greater than 500 nm (preferably greater than 1.0 microns, more preferably greater than or equal to about 5 microns, and most preferably greater than 10 microns) over and between the plurality of light emitting elements in the light emitting area of the OLED.

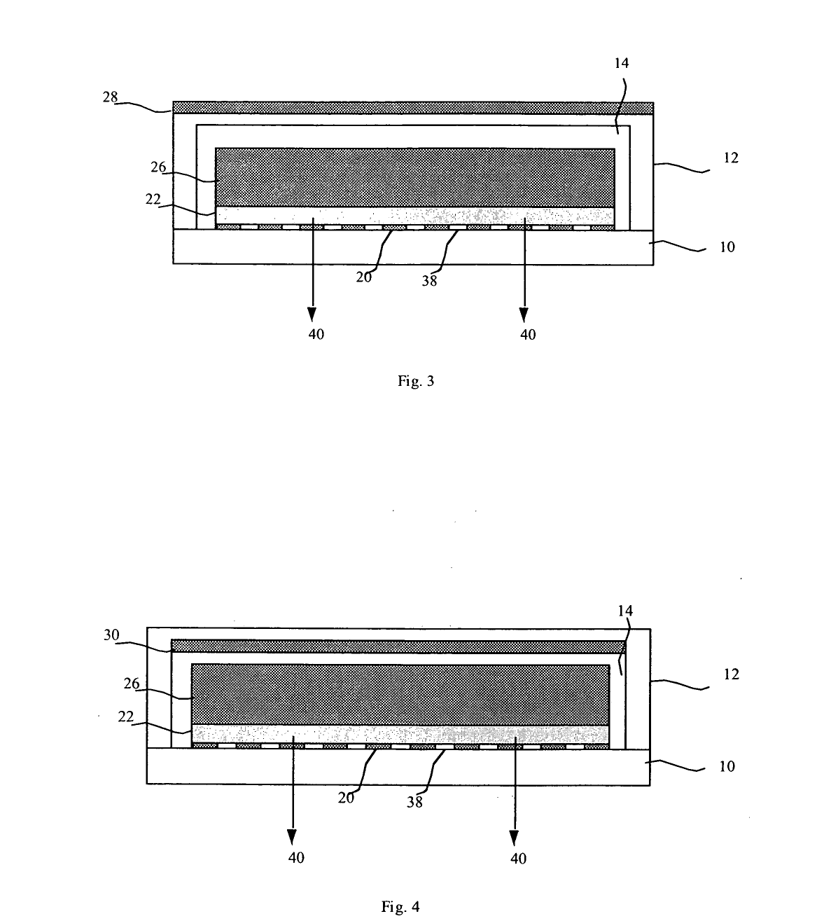

In a second embodiment, the cover 12 may include a thermally conductive layer or a backplate, such as described in commonly assigned, copending U.S. Ser. No. 10/722,243, filed Nov. 25, 2003 and Ser. No. 10/785,825, filed Feb. 24, 2004, the disclosures of which are incorporated by reference herein. Referring to FIG. 3, a heat conductive layer 28 is coated over the exterior of the cover. The heat conductive layer 28 may be made of one or more layers of a metal or metal alloy, for example silver, aluminum, tin, copper, steel, iron, chromium or magnesium and may have a thickness of, for example at least 10 microns, more preferably at least about 100 microns. Applicants have demonstrated good results with a 100-micron coating of aluminum on the cover of a bottom emitting active-matrix OLED device. The thermally conductive layer may have a coefficient of thermal expansion matched to that of the cover.

The substrate and cover may be rigid and composed of, for example, glass or they may be flexible and composed of, for example, plastic. Likewise, the thermally conductive layer may be rigid or flexible. The thermally conductive layers may also acts as a barrier layer to prevent the passage of gas or liquids that may otherwise contaminate the OLED materials.

In a third embodiment, the cover 12 may include an alternative thermally conductive metallic layer. Referring to FIG. 4, a heat conductive layer 30 is coated on the inside surface of the cover. The heat conductive layer 30 may be made of one or more layers of a metal or metal alloy, for example silver, aluminum, tin, copper, steel, iron, chromium or magnesium and may have a thickness of, for example at least to and preferably at least about 100 microns.

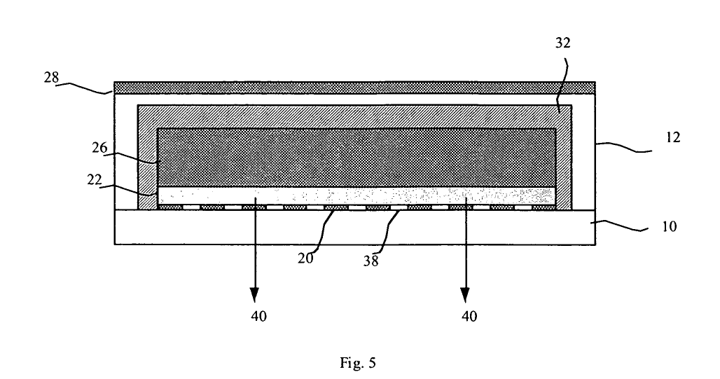

In a fourth embodiment, the gap separating the second electrode from the cover may be filled with a thermally conductive material 32. Referring to FIG. 5, a thermally conductive material 14 fills the gap between the thick second electrode 26 and the cover 12. The thermally conductive material 14 may be made of, for example a thermally conductive material such as polymers and silicones. Additives such as metallic or ceramic particles and nano-materials including metallic or carbon components may be employed in the thermally conductive material. Alternatively, thermally conductive polymers, for example, Gap Pad material having a thermal conductivity of 2.0 W/mK commercially available from the The Bergquist Company, may be employed. Polymers having special formulations providing thermal conductivity may be employed, for example thermally conductive tapes with a thermal conductivity of 0.6 W/mK available from the 3M Company. Thermally conductive pads having a thermal conductivity of 2.3 W/mK to 5.0 W/mK are also available from the Bergquist and 3M companies. Silicone materials are also useful, for example, Sil Pad material having a thermal conductivity of 1.3 W/mK commercially available from the The Bergquist Company, or silicone grease. Adhesives having a high thermal conductivity may also be employed, for example, 0.7 W/mK, available from the 3M Company.

The thermally conductive material may be a flexible solid. Gels may be employed. Preferably, the material fills the cavity between the second electrode and the cover at least over the light-emitting area of the OLED device. Thermally conductive materials can be applied in liquid form and may be cured to form a thermally conductive, conformable solid. Liquid application has the advantage that a liquid readily conforms to the volume and shape needed. Compressible materials may also be employed. Thermally conductive phase change materials may also be employed, for example Hi Flow material commercially available from The Bergquist Company. The thermally conductive materials may also have desiccating properties, thereby enhancing the lifetime of the OLED materials. The thermally conductive materials may be made of more than one material type, for example a matrix having a first thermal conductivity and particles of a second material having a second, higher thermal conductivity, for example ceramic particles, glass or glass beads, nano-materials, and carbon.

In a fifth embodiment, not shown, the thick second electrode 24 may be covered with an encapsulating cover in the form of a conforming encapsulating layer, so that no gap is present. Alternatively, the thick second electrode may be covered with a conforming encapsulating layer and an additional non-conforming cover. In any of such embodiments, the conforming layer may take the form of environmental protective layers (e.g., polymer layers or materials deposited by chemical vapor deposition processes) as are known in the art. For example, using sequential depositions of vaporized materials over a metal cathode, conformal environmentally protective layers may be grown on the second electrode to prevent the ingress of moisture or other deleterious gases. In these embodiments, a metal coating or additional thermally conductive layer(s) may be positioned over the conforming encapsulating layer or additional environmental protective layers in addition to the metal coatings on the inside or outside of any non-conforming additional cover (if present), or in the gap between the thick second electrode a non-conforming additional cover (if present) to further spread heat in the OLED device. Any or all of these embodiments may be combined. For example, a thick second electrode may be employed with the metal coating on the outside of the cover, on the inside of the cover, and the gap may be filled with a thermally conductive material.

In operation, OLED devices are provided with a voltage differential across the electrodes by an external power supply (not shown). The voltage differential causes a current to flow through the OLED materials causing the OLED materials to emit light. However, the conversion of current to light is relatively inefficient, so that much of the energy is converted to heat. Moreover, much of the emitted light does not escape from the OLED device and is reabsorbed into the device as heat. Hence, OLED devices can become very hot and operate at temperatures well in excess of ambient temperatures. For example, in an ambient environment of 20° C., applicants have demonstrated that an OLED may operate at 40° C. to 60° C. or even, at very high brightnesses, in excess of 100° C. This heat is detrimental to the OLED device and may be dangerous to a user. As is well known, OLED materials degrade as they are used and degrade faster at higher temperatures. Therefore, providing improved heat management to cool an OLED device improves the lifetime of the OLED device.

In a conventional, prior-art OLED device (as shown in FIG. 2), the heat generated within the OLED layers 22 must pass through the electrodes before it can escape from the OLED device. Some of the heat can pass through the first electrode 20 and thence through the substrate 10 while some of the heat passes through the second electrode 24, the cavity 14, and the encapsulating cover 12. The thermal conductivity of the cavity 14 may be 0.025 W/mK (if filled with air) or 0.25 W/mK for conventional polymeric materials as described in the prior art. The second electrode 24 is typically made of metal (for example silver or aluminum) or a metal oxide (for example, indium tin oxide) or metal alloys. These electrode materials are relatively good conductors of heat. Unfortunately, the electrodes in prior art devices are typically thin films, for example 2-200 nm thick. Applicant has demonstrated that such thin films of metals do not provide adequate heat conductivity.

According to the present invention, one of the plurality of light emitting elements may be activated to generate light, while others remain inactive. The activated elements will produce heat, which is detrimental to the lifetime of the activated elements of the OLED device, and may result in differential aging of the elements. By employing a continuous thick cathode, heat is spread from the activated light emitting elements to the inactive light emitting elements, thereby reducing the temperature of the activated elements, and increasing their lifetime. The heat spread to the inactive elements at conventional operating temperatures does not substantially degrade the materials.

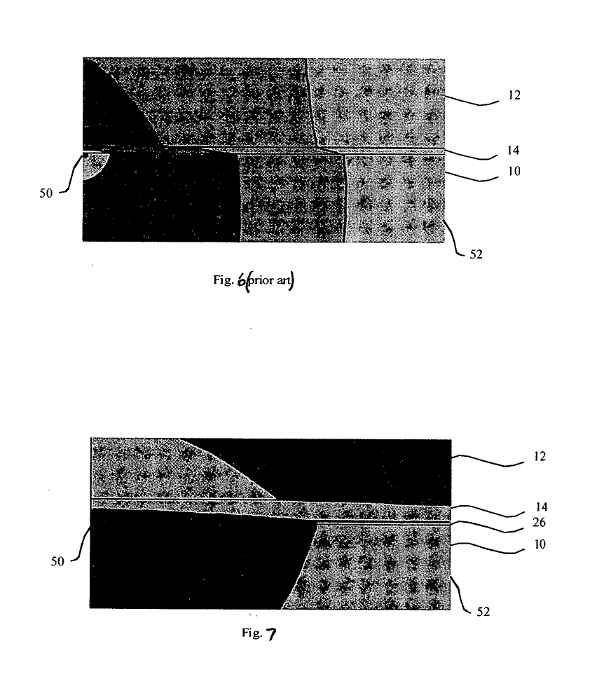

Referring to FIG. 6, a thermal model of the prior-art OLED shown in FIG. 2 is illustrated. In this structure, as shown in FIG. 2, a portion of a transparent glass substrate 10 (700 microns thick) is encapsulated by a glass cover 12 (also 700 microns thick). A 50-micron air-filled cavity 14 is provided to simulate the cavity that may be present in OLED devices between the second electrode 24 and the encapsulating cover 12. A 400 nm metallic aluminum cathode (not shown) is provided over the substrate 10. Energy is applied to a single point 50 on the transparent substrate 10. The applied energy raises the temperature of the point to 47° C. Similarly shaded areas in FIG. 6 represent areas within a band of the same approximate temperature. However, as has been demonstrated experimentally by applicant, the greatest lifetime savings can be achieved if the temperature of the materials can be reduced to near, and preferably below, 40° C. because of the non-linear aging response to operating temperature of the OLED devices.

Referring to FIG. 7, a thermal model of the embodiment of the present invention shown in FIG. 1 is illustrated. In this structure, a portion of a transparent glass substrate 10 (700 microns thick) is encapsulated by a glass cover 12 (also 700 microns thick). A 45-micron air-filled cavity 14 is provided to simulate the cavity that may be present in OLED devices between the second electrode 24 and the encapsulating cover 12. A 5-micron thick metallic aluminum cathode 26 is provided over the substrate 10. Energy (equivalent to that in FIG. 6) is applied to a single point 50 on the transparent substrate 10. The applied energy raises the temperature of the point to only 41° C. As in FIG. 6, similarly shaded areas in FIG. 7 represent areas within a band of the same approximate temperature.

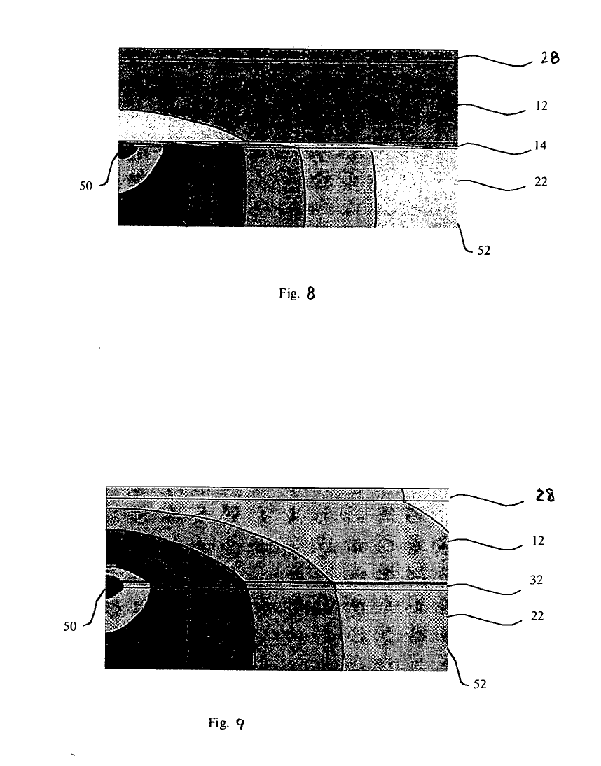

Referring to FIG. 8, a thermal model of the embodiment of the present invention shown in FIG. 3 is illustrated. In this structure, in addition to employing a 5-micron thick aluminum cathode as in FIG. 7, an additional 100-micron heat conductive layer 28 of aluminum is added over the cover 12. The applied energy now raises the temperature of the point 50 to only 32° C. Referring to FIG. 9, a thermal model of the embodiment of the present invention shown in FIG. 5 is illustrated. In this structure, in addition to employing a 5-micron thick aluminum cathode and an additional 100-micron thick heat conductive layer 28 of aluminum as in FIG. 8, the gap 14 is filled with thermally conductive material 32 (3M 5509 thermally conductive material, 5.0 W/mK). The applied energy now raises the temperature of the point to only 30° C.

FIGS. 7 and 8 demonstrate the results for thermal models employing 5-micron thick metallic cathodes. Additional modeling done by Applicant demonstrates that additional benefit will be obtained by providing continuous cathodes having a thickness greater than 10 microns. Use of a 50-micron thick continuous cathode in the model of FIG. 7, e.g., will result in the applied energy raising the temperature of point 50 to only 30° C.

Heat may additionally be removed from the OLED display of the present invention by using conventional heat-sinks in thermal contact with any external layers, for example by locating such heat sinks on the outside of the cover either in the center of the OLED device or at the edges. When used within an appliance, the appliance may be placed in thermal contact with OLED device, especially in combination with the use of thermally conductive layers on the outside of the OLED device as described above.

The invention has been described in detail with particular reference to certain preferred embodiments thereof, but it will be understood that variations and modifications can be effected within the spirit and scope of the invention. Accordingly, the preferred embodiments of the invention as described in reference to FIGS. 1, 3, 4, and 5 are intended to be illustrative, not limiting.

PARTS LIST

| | |
|---|---|
| 10 | substrate |
| 12 | encapsulating cover |
| 14 | cavity |
| 20 | first electrode |
| 22 | OLED layers |
| 24 | second electrode |
| 26 | thick metallic electrode |
| 28 | heat conductive layer |
| 30 | heat conductive layer |
| 32 | heat conductive material |
| 38 | insulator |
| 40 | light |
| 50 | energy application point |
| 52 | temperature band |

1. A bottom-emitting OLED device comprising:
a) a transparent substrate;
b) a plurality of OLED light emitting elements located on the substrate, each light emitting element including a first patterned transparent electrode formed over the substrate and one or more OLED light emissive layers located over the first electrode and emitting light through the first electrode, and a continuous second electrode metallic layer located over the plurality of OLED light emitting elements, wherein the second electrode metallic layer has a continuous thickness greater than 500 nm over and between the plurality of light emitting elements; and
c) an encapsulating cover located over the second electrode.

2. The OLED device claimed in claim 1 wherein the cover has two sides and further comprising a thermally conductive layer located on either or both sides of the cover.

3. The OLED device claimed in claim 2 wherein the thermally conductive layer comprises a metal or metal alloy.

4. The OLED device claimed in claim 3 wherein the thermally conductive layer comprises one or more of silver, aluminum, tin, copper, steel, iron, chromium and/or magnesium.

5. The OLED device claimed in claim 2 wherein the thermally conductive layer is thicker than 10 microns.

6. The OLED display claimed in claim 2 wherein the substrate or cover is flexible.

7. The OLED display claimed in claim 6 wherein the thermally-conductive layer is flexible.

8. The OLED device claimed in claim 1 further comprising a protective layer located between the cover and the second electrode.

9. The OLED device claimed in claim 8 further comprising a thermally conductive layer located between the protective layer and the cover.

10. The OLED device claimed in claim 1 further comprising a gap between the cover and the second electrode.

11. The OLED device claimed in claim 10 wherein the gap is filled with a thermally conductive material.

12. The OLED device claimed in claim 11 wherein the thermally-conductive material is a polymer or silicone.

13. The OLED device claimed in claim 11 wherein the thermally-conductive material has desiccating properties.

14. The OLED device claimed in claim 11 wherein the thermally-conductive material includes a first material and particles of a second thermally-conductive material distributed through the first material and having a thermal conductivity higher than the thermal conductivity of the first material.

15. The OLED device claimed in claim 14 wherein the second thermally-conductive material is a metal, a metal alloy, a glass, and/or a ceramic.

16. The OLED device claimed in claim 11 wherein the thermally-conductive material is deposited as a liquid and is cured to form a solid.

17. The OLED device claimed in claim 11 wherein the thermally-conductive material is a gel or grease.

18. The OLED display claimed in claim 1 wherein the substrate or cover is flexible.

19. The OLED display claimed in claim 1 further comprising a heat sink provided in thermal contact with the OLED device.

20. The OLED display claimed in claim 19 wherein the heat sink is provided in thermal contact with a thermally conductive layer located on the outside of the cover.

21. The OLED display claimed in claim 1 further comprising an appliance provided in thermal contact with the OLED device.

22. The OLED display claimed in claim 21 wherein the appliance is provided in thermal contact with a thermally conductive layer located on the outside of the cover.

23. The OLED display claimed in claim 1 wherein the encapsulating cover is a conforming layer coated on the second electrode or on a protective layer located over the second electrode.

24. The OLED display claimed in claim 1 wherein the second electrode has a continuous thickness greater than 1.0 microns.

25. The OLED display claimed in claim 1 wherein the second electrode has a thickness greater than or equal to about 5 microns.

26. The OLED display claimed in claim 1 wherein the second electrode has a thickness greater than 10 microns.
